(19) United States
(12) Patent Application Publication
(10) Pub. No.: US 2009/0188503 A1
(43) Pub. Date: Jul. 30, 2009

(54) SUB-TIDAL VOLUME REBREATHER AND SECOND STAGE REGULATOR

(76) Inventor: Jan-Philip Chenevier Brandt, New York, NY (US)

Correspondence Address: GOODWIN PROCTER LLP;ATTN: PATENT ADMINISTRATOR, 620 Eighth Avenue, NEW YORK, NY, 10018, US

(21) Appl. No.: 11/910,856

(22) PCT Filed: Apr. 6, 2006
(86) PCT No.: PCT/US06/13136

§ 371 Date: Sep. 19, 2008

Related U.S. Application Data
(60) Provisional application No. 60/669,155, filed on Apr. 7, 2005.

(51) Int. Cl. B63C 11/24; B63C 11/22; A62B 7/08

(52) U.S. Cl. 128/205.12; 128/205.28; 128/205.24

(57) ABSTRACT

Presented is a sub-tidal volume rebreather (STVR) and various embodiments that extend the useful range and/or reduce the encumbrance of any breathable gas, whether filtered, compressed, or otherwise, used by a diver, serviceman, fireman, or other user of such equipment. In an exemplary embodiment the second stage regulator (Reg2) of the rebreather (STVR) is connected via an ambient pressure breathing tube (APTR) to an overpressure relief valve (ORV), which is again connected to a sub-tidal volume counter lung (STVcI) via a C02 absorbent canister (Scrub). During each exhalation, upon maximum inflation of the sub-tidal volume counter lung (STVcI), the overpressure relief valve (ORV) releases the heavily C02 laden back portion of the user's respiratory tidal volume (RTV) before it reaches the C02 absorbent chemical in its canister (Scrub).

### RELATED APPLICATIONS

This application claims benefit of U.S. Provisional Patent Application No. 60/669,155, filed on Apr. 7, 2005, the text of which is incorporated herein by reference in its entirety.

### FIELD OF THE INVENTION

The present invention relates to apparatus and methods of using such apparatus to extend the useful range and/or reduce the encumbrance of any breathable gas, whether filtered, compresses, or otherwise, used by a diver, serviceman, fireman, or other user of such equipment.

### BACKGROUND OF THE INVENTION

All rebreathers generally have certain basic components in common. Typically, designs function with a breathing loop to which is attached a collapsible bag referred to as a counter-lung (equal to or larger than the diver's Respiratory Tidal Volume) that inflates when the diver exhales, and deflates when the diver inhales, a CO₂ absorbent canister containing a CO₂ absorbing chemical (soda lime or lithium hydroxide) and some sort of breathing gas injection system allowing the replenishment of the metabolized oxygen.

On open-circuit scuba, if a diver can breathe and is not outside well-established depth limits, the breathing gas is going to be life-sustaining (assuming the cylinder was filled properly). If there is a problem with an open-circuit system, the problem is usually very self-evident to the diver, so the diver at least is aware of the problem and can takes steps toward a solution.

On the other hand, the breathing gas in rebreathers is dynamic, and thus the oxygen concentration may drift out of life-sustaining range within the course of a single dive. It is possible that an unaware diver may breathe-up all of the oxygen in the breathing loop before the oxygen addition valve is triggered, thus leaving only nitrogen . . . and an unconscious diver.

In the case of semi-closed rebreathers, oxygen concentration in the breathing loop depends on diver workload. Under certain circumstances, especially during high exertion and/or during an ascent, the oxygen concentration in a semi-closed rebreather could drop to dangerously low levels.

An inherent weakness of closed-circuit rebreathers is the reliance on electronics to control the oxygen concentration in the breathing loop. As any underwater photographer knows, electronics and water (particularly salt water) do not mix. Indeed, closed-circuit rebreathers have earned a somewhat notorious reputation as being “unreliable”, largely due to failures of the electronic O₂ control system (leading to either too much, or too little oxygen in the breathing loop).

### SUMMARY OF THE INVENTION

As described herein a breathing apparatus including a Sub-Tidal Volume Rebreather (STVR) is presented. In addition to reducing the gas supply carried and consumed by the user various embodiments of the device also provide for healthy life sustaining levels of oxygen recycled from the source without the need for monitoring, controlling or displaying the partial pressure of oxygen within the recycled gas mixture.

### LIST OF FIGURES

FIG. 1 is a front view of a single-hosed pendulum embodiment of the device attached to the air chamber of a second stage regulator.

FIG. 2 is a front view of a version of the invention included in a double-hosed breathing loop.

FIG. 3 is a front view of the device according to one aspect of the invention utilizing a filtered non compressed gas source.

FIG. 4 is a top view of an STVR-dedicated second stage regulator allowing the alternative use of standard open-circuit equipment.

### LIST OF ABBREVIATIONS

APBT—Ambient Pressure Breathing Tube
BGF—Breathing Gas Filter
BGT—Breathing Gas Tank
DHBL—Double-Hosed Breathing Loop
IV—Isolation Valve
MP—Medium Pressure hose
ORV—Overpressure Relief Valve
Reg1—First Stage Regulator
Reg2—Second Stage Regulator
Scrub—CO₂ absorbent canister
STVcl—Sub-Tidal Volume counter-lung
STVR—Sub-Tidal Volume Rebreather
RTV—Respiratory Tidal Volume
RMV—Respiratory Minute Volume
DSReg2—Dedicated Second Stage regulator

### DETAILED DESCRIPTION OF THE INVENTION

For the purpose of illustration, the STVR, according to one or more embodiments of the invention, can be best understood with a discussion of the following elements of an exemplary embodiment. It will be appreciated that certain elements presented can be combined, omitted, or arranged differently according to other aspects of the invention:

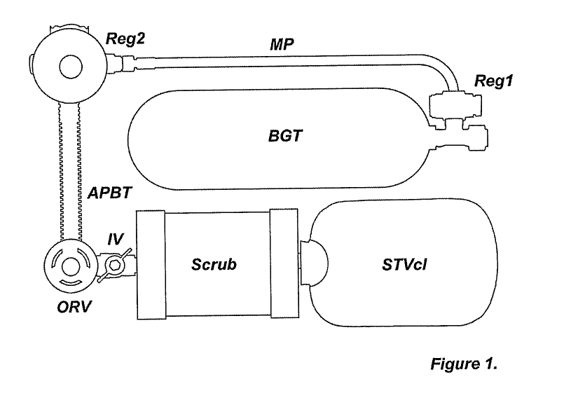

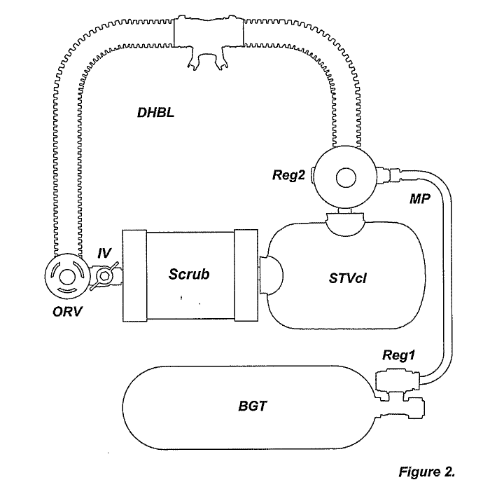

### Sub-Tidal Volume Counter-Lung (STVcl in FIGS. 1, 2 & 3)

Rather than a breathing loop of a closed circuit SCUBA system, the STVR uses a sub-tidal volume counter-lung (STVcl) which allows the system to retain and recycle only the front, least CO₂ laden, portion (approximately 1 to 2 litres) of the diver's Respiratory Tidal Volume (RTV) upon each exhalation.

Remaining constant as the diver's Respiratory Minute Volume (RMV) (the volume of gas consumed by the diver per minute) augments during workload or stress increase, the STVcl ensures that the demand for extra fresh gas, upon its' bottoming-out, is quenched by the Fresh Breathing Gas Addition System.

The deeper the user breathes; the more fresh gas he inhales.

System hypoxia can only be obtained by voluntary shallow breathing combined with bypassing fresh gas injection. This, however, results in blood system CO₂ build-up (even though the counter-lung air has been scrubbed of CO₂) followed by the “gasping reflex” (invoked by mild hypercapnea) and a series of deep, oxygenated breaths, direct from the tank, long before the onset of hypoxia.

CNS (Central Nervous System) oxygen toxicity is not a consideration as the use of air and the respect of air diving rules and limitations keep the diver well within acceptable limits (0.16<ppO2<1.6). The same rule applies to Mixed Gas diving (Nitrox, HeliOx, TriMix.)

### Ambient Pressure Breathing Tube or Connector (APBT in FIGS. 1 & 3)

A flexible tube or connector with an inner diameter of approximately 10 mm to 50 mm connecting the User Interface to the Overpressure Relief Valve and the CO₂ Absorbent Canister & Isolation Valve. Allowing the breathing gas to flow with little or no resistance during normal, calm breathing, the limited inner diameter of the tube acts as a passive system by-pass. Any increase in the breathing gas flow speed (High RMV is accompanied by a rise in respiration frequency) raises breathing resistance within the system and automatically triggers fresh gas flow directly from the Fresh Breathing Gas Addition System.

The faster the user breathes; the more fresh gas he inhales.

### Overpressure Relief Valve (ORV in FIGS. 1, 2 & 3)

Connected to the Ambient Pressure Breathing Tube and the CO₂ Absorbent Canister & Isolation Valve, this valve, upon maximum inflation of the STVcl, releases the heavily CO₂ laden back portion of the diver's RTV into the water upon each exhalation, before it reaches the CO₂ absorbent chemical contained in its canister. In particular embodiments, the ORV is adjustable such that the pressure at which it releases can be changed.

### User Interface (Reg2, DSReg2, DHBL & BGF in FIGS. 1, 2, 3 & 4)

The Ambient Pressure Breathing Tube or Connector attaches to the air chamber of a second stage regulator, a mouthpiece, a double-hosed breathing loop or a filter system allowing the simultaneous use of the STVR and the users' primary source of Fresh Breathing Gas.

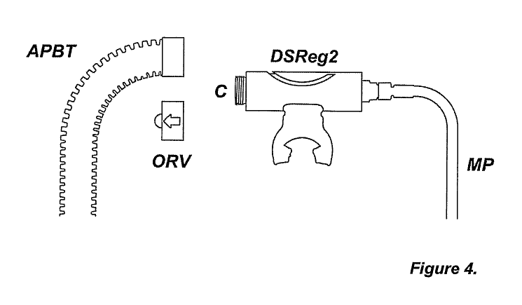

In one embodiment, the second-stage regulator is a DSReg2 allowing the user to switch between standard open-circuit SCUBA and STVR modes. In certain embodiments, the regulator comprises a threaded connector, speed-connector, selection wheel or conversion coupling to allow the user to alternate the mode of operation between that of standard open-circuit SCUBA and STVR enhanced operation. A particular embodiment is depicted in FIG. 4. In other embodiments, the ORV is attached to the regulator and the APBT is attached or detached to alternate between the two modes of operation. In another embodiment, the ORV is attached to the regulator and alternating between the two modes of operation is effected by a shut-off valve located between the ORV and the Scrub/STVcl such that, when the valve is shut-off, gas no longer flows into the Scrub/STVcl. The selection between the two modes of operation can be performed at any time or under any circumstance (e.g., at the surface or under water) for any purpose (e.g., should the STVR become inoperable, e.g., clogged, flooded or incomplete).

### CO₂ Absorbent Canister & Isolation Valve (Scrub & IV in FIGS. 1, 2 & 3)

Most of the CO₂ exhaled by the diver is released into the water. This allows the use of much less (approximately 1/10^{th}) CO₂ absorbing chemical contained in the canister per dive than with conventional rebreathers. The CO₂ absorbing chemical is changed at each tank refill eliminating the need to clock chemical life during and between dives and virtually eliminating the risk of hypercapnea.

An Isolation Valve connecting the CO₂ Absorbent Canister to the Adjustable Overpressure Relief Valve and/or Ambient Pressure Breathing Tube allows the diver to switch back and forth to full Open-Circuit SCUBA (without the need of changing mouth-pieces) in the event of system failure, flooding or surface swimming.

The STVR can be comprised of a counter-lung of inferior volume than that of the users' RTV and is connected to the air chamber of a second stage regulator, a mouthpiece, a double-hosed breathing loop or a filter system by an adapter via a CO₂ absorbent canister and an overpressure relief valve.

Also, in one embodiment the counter-lung volume can be a minimum of approximately 1 litre and a maximum of approximately ¾ of the users' RTV during light or normal activity at sea level (1 ATA).

In another embodiment the ambient pressure breathing hose(s) is(are) of an internal diameter (10 mm to 50 mm), length and shape as to allow for natural air flow at relaxed or light activity RMV.

In yet another embodiment the CO₂ absorbent canister is located between the overpressure relief valve and the counter-lung or within said counter-lung.

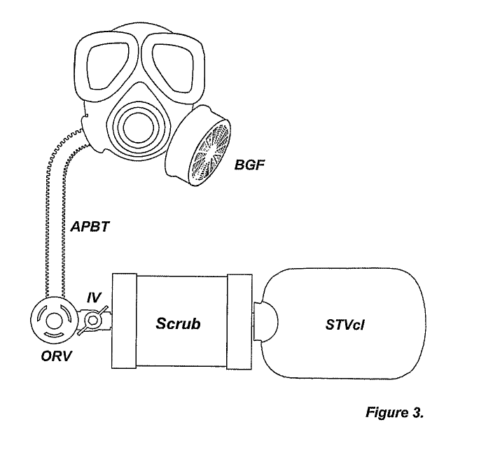

In one method, according to another aspect of the invention, a device is provided wherein an Ambient Pressure Breathing Tube (APBT) (FIGS. 1. & 3.), or connector, of a section and/or length as to allow natural air flow at the users' normal RMV connects a second stage regulators' air chamber (Reg2) (FIG. 1.), a mouthpiece, a Double-Hosed Breathing Loop (DHBL) (FIG. 2.) or a breathing gas filter (BGF) (FIG. 3.) to a Sub-Tidal Volume counter-lung (STVcl) of inferior volume than that of the users RTV via an isolation valve (IV), an Overpressure Relief Valve (ORV) and a CO₂ Absorbent Canister (Scrub). Counter-lung (STVcl) which, when fully inflated upon the users' exhalation, forces the heavily CO₂ laden back portion of the users' exhaled Respiratory Tidal Volume out of the system via the aforementioned Overpressure Relief Valve (ORV) before it can reach the consumable contained in the CO₂ absorbent canister (Scrub). The full deflation of said counter-lung (STVcl), upon the users' inhalation, triggers Fresh Gas Injection, be it of a compressed (BGT/Reg1/MP/Reg2) (FIGS. 1. & 2.) or ambient (BGF) (FIG. 3.) source, completing the users' inhaled RTV.

### Method of Using the STVR

Using FIG. 1 and FIG. 4 as an exemplary embodiment and assuming the STVcl is bottomed-out (empty) prior to the users' first inhalation, the said user engages the following protocol:

The user inhales his full RTV through Reg2 or DSReg2 supplied entirely by the Fresh Breathing Gas Addition System composed of, in this case, BGT/Reg1/MP/Reg2 (or DSReg2).

He then proceeds to exhale the front portion of his RTV through Reg2 (or DSReg2)/APBT/ORV/IV/Scrub into STVcl . . . .

which, upon full inflation, forces the heavily CO₂ laden back portion of the users' exhaled RTV out of the system, via the ORV, before it reaches the CO₂ Absorbent Chemical contained in Scrub.

As the user inhales the CO₂ Scrubbed air contained in the STVR, the bottoming-out of the STVcl triggers the Fresh Breathing Gas Addition System, in this case: BGT/Reg1/MP/Reg2 (or DSReg2), quenching the demand on the system by the user to complement his inhaled RTV.

### Ranges, Materials, and Variations

Though the examples provided above include certain values, materials, and orientation and location of elements, other possibilities exist and are within the spirit of various embodiments of the invention.

For example, the ambient air hose means could have a round, oval, rectangular, triangular, or flat tape like cross-section. The cross-sectional area and total volume of the hose should generally be as small as possible so that the most possible amount of the exhaled breath is treated by the canister or scrubber means. One of ordinary skill in the art will recognize that a hose or tube of a very narrow profile will limit the amount and speed that the air will travel through it when propelled by the lungs (such as trying to exhale out of a straw). Accordingly, hoses according to one or more embodiments of the invention have diameters in the range of 10 mm to 50 mm or a cross-sectional area of around 1 cm2 to 10 cm2. Such hoses or tube should be of the lowest possible internal volume as to ensure the least amount of dead-air space in the system. Moreover, in another particular embodiment the hose is eliminated and replaced by connection members or means for directly connecting the scrubber and counter-lung to the mouthpiece. In another embodiment the scrubber is housed concentrically within the counter-lung and the overpressure valve is proximal to the mouthpiece.

Scrubbers, canisters, and CO₂ removal means or treatments devices are well known in the art and though embodiments described herein utilizes soda-lime other chemicals and devices can be utilized according to the method and apparatus.

The counter-lung or bladder like device or means can be made of various flexible materials known in the art or semi-rigid accordion like devices having the ability to collapse and change volume. The volume of the counter-lung or bladder can be set or adjustable allowing the user to fine-tune the amount of air to be recycled at various depths or to accommodate individuals of various lung capacities

As discussed above the rebreather device can be used with compressed air or mixed gas supplied from a tank. However other configurations using compressed air from other sources such as a surface compressor are also possible. Alternatively the primary source of air to be recycled need not be from a compressed source, for example a sub-tidal volume counter-lung and canister arrangement according to one embodiment of the invention could be configured for use with a gas mask or filter mask to prolong the filter or limit the amount of toxic air inhaled.

Throughout this document the user has been referred to as: the diver. This is for illustrative purposes as a diver is the highest standard demanding user of this sort of equipment. Moreover, one or more methods of the invention may be adapted for use with closed or semi closes circuit SCUBA, gas masks and other non-compresses air breathing apparatuses.

### EXAMPLES

### Example 1

Table 1 illustrates the improvement of performance of a standard air tank (in this case a Scubapro 8.89 1.230 bar max.) which, without the STVR and under the same test conditions, sustained the user for 1 h05. This corresponds to an improvement of performance of 415%.

TABLE 1
STVR Surface Test (Counterlung Vol: 11.)
250 g DiveSorb ® Sodalime.

| T(h/m) | VO2 (%) | VCO2 (%) | Tank(bars) |
|---|---|---|---|
| 0 m | 20.7 | 0 | 220 |
| 15 m | 17.1 | 0.57 | 210 |
| 30 m | 17.6 | 0.34 | 200 |
| 45 m | 17.1 | 0.76 | 187 |
| 1 h 00 m | 17.3 | 0.54 | 178 |
| 1 h 15 m | 18.2 | 0.46 | 165 |
| 1 h 30 m | 18.3 | 0.42 | 155 |
| 1 h 45 m | 18.3 | 0.46 | 145 |
| 2 h 00 m | 18 | 0.51 | 135 |
| 2 h 15 m | 18.6 | 0.5 | 120 |
| 2 h 30 m | 18.3 | 0.49 | 112 |
| 2 h 45 m | 18.7 | 0.57 | 100 |
| 3 h 00 m | 18.7 | 0.61 | 92 |
| 3 h 15 m | 18.3 | 0.67 | 80 |
| 3 h 30 m | 18.1 | 0.61 | 65 |
| 3 h 45 m | 18.3 | 0.68 | 50 |
| 4 h 00 m | 18.4 | 0.94 | 40 |
| 4 h 15 m | 19.2 | 0.71 | 25 |
| 4 h 30 m | 18.5 | 1.14 | 20 |
| Tolerances | 16 < VO2 < 160 | 0 < VCO2 < 2.5 | 10 < TP < 230 |

Tests using a single ScubaPro 8.89 litre air tank during light activity.
All mesurement sampled from Inhale Volume (pre-inhale.)
All tests run with: Dräger Multiwarn II Serial No.: ARSH-2774

While this invention has been particularly shown and described with references to preferred embodiments thereof, it will be understood by those skilled in the art that various changes in form and details may be made therein without departing from the scope of the invention encompassed by the appended claims.

What is claimed is:

1. An air recycling apparatus for use with open circuit breathing apparatus comprising:
an ambient pressure hose having a first and second end wherein said first end is adapted for coupling to an inlet of a second stage regulator;
a sub-tidal volume counter-lung coupled to the ambient pressure hose at said second end;
a scrubber operable to deplete CO2 gas connected along said hose; and
an overpressure relief valve having a threshold greater than ambient pressure coupled to said hose.

2. An air recycling apparatus according to claim 1 wherein the counter-lung volume is approximately one to five liters.

3. An air recycling apparatus according to claim 1 wherein the hose has an internal diameter between 10 and 50 mm.

4. An air recycling apparatus according to claim 1 wherein the CO2 scrubber is located concentrically with the counter-lung.

5. An air recycling apparatus according to claim 1, wherein the overpressure relief valve is located between the first end of the hose and the scrubber.

6. An air recycling apparatus according to claim 1 wherein the counter-lung volume is approximately around ¾ of a user's respiratory tidal volume during light or normal activity at 1ATM.

7. An air recycling apparatus according to claim 1 wherein the counter-lung has a variable and adjustable volume.

8. An air recycling apparatus according to claim 1 wherein the hose is 0.5 cm to 100 cm in length.

9. A method for partially recycling air from an air source without monitoring or controlling the partial pressure of oxygen of the recycled air comprising:
providing a mouthpiece connected to said air source and operable to direct exhaled gas though a CO2 scrubber and into a sub-tidal volume counter-lung;
exhaling into the mouthpiece wherein the air is treated by the scrubber and then fills the counter-lung adapted to hold less than a lung tidal volume of a given exhale whereupon an overpressure relief valve in fluid communication with the counter-lung releases an overflow volume of the exhaled gas;
inhaling the treated air from said mouthpiece until said counter-lung is evacuated; and
completing the inhalation from said air source.

10. A method for recycling air from a compressed air breathing apparatus comprising:
providing a mouthpiece connected to said air breathing apparatus and operable to direct exhaled gas though a CO2 scrubber and into a sub-tidal volume counter-lung adapted to hold less than a lung tidal volume of a given exhale and to direct a remainder of a tidal volume through an overpressure valve;
exhaling into the mouthpiece;
removing the CO2 from the exhaled air;
filling the counter-lung and releasing the remainder of a tidal volume through an overpressure valve;
inhaling from said mouthpiece until said filled counter-lung is evacuated thereby creating a vacuum within the mouthpiece and triggering flow from said compressed air breathing apparatus; and
completing the inhalation from said compressed air breathing apparatus.

11. A demand supplying second stage regulator wherein the exhaust mechanism is configured to allow the exchange of an ambient pressure breathing tube with an overpressure relief valve.

12. The demand supplying second stage regulator of claim 11, wherein the exhaust mechanism comprises a threaded connector, a speed-connector, a selection wheel or a conversion coupling.
